(19) United States
(12) Patent Application Publication
(10) Pub. No.: US 2025/0154984 A1
(43) Pub. Date: May 15, 2025

(54) MAGNETIC BEARING FOR SUPPORTING AN RC PISTON

(71) Applicant: NUOVO PIGNONE TECNOLOGIE - S.R.L., Florence (IT)

(72) Inventors: Massimiliano ORTIZ NERI, Pisa (IT); Francesco CHIESI, Firenze (IT); Alessio CAPANNI, Arezzo (IT); Simone BASSANI, Firenze (IT)

(21) Appl. No.: 18/726,965

(22) PCT Filed: Jan. 10, 2023
(86) PCT No.: PCT/EP2023/025004

§ 371 Date: Jul. 5, 2024

(30) Foreign Application Priority Data
Jan. 11, 2022 (IT) 102022000000263

(51) Int. Cl. F16C 32/04; F04B 19/22; F04B 53/14

(52) U.S. Cl. CPC F16C 32/0472; F04B 19/22; F04B 53/144; F16C 2360/42

(57) ABSTRACT

A magnetic bearing for supporting the movement of a piston sliding into a cylinder comprised in a compressor. The piston comprises a first rod that connects the piston to a cross-head of the compressor and an extension rod, which is connected to the first rod. The magnetic bearing comprises a first group of magnets arranged on a first side of the extension rod of the piston, a second group of magnets arranged on a second side of the extension rod of the piston, wherein the magnetic forces exerted by the first group of magnets and the second group of magnets respectively allow the piston to be supported during its movement. The present disclosure also concerns a method of assembling a magnetic bearing.

### TECHNICAL FIELD

The present disclosure concerns a magnetic bearing for supporting the movement of a piston operating in a reciprocating compressor (RC), for instance, a reciprocating compressor used in oil refineries plants, gas pipelines, like hydrogen or energy transition plants, chemical plants, natural gas processing plants, air conditioning, and refrigeration plants.

### BACKGROUND ART

The reciprocating compressors, which are also known as piston compressors, are generally used to increase the pressure of gases. In particular, the reciprocating compressors fall into the category of positive-displacement compressors, i.e., compressors dealing with a specific quantity of air or gas contained in a compression chamber, wherein its volume is mechanically reduced, to increase its pressure.

The above compressors are usually implemented in liquefied natural gas (LNG) plants, where the extracted gas is cooled down to liquid form for the safety of non-pressurized storage or transport.

Usually, although not necessarily, the reciprocating compressors have a horizontally balanced frame arrangement. Such arrangement has some advantages in terms of size and stability. In such horizontally balanced frame arrangements, the weight of a reciprocating compressor piston is borne by rider bands installed on the piston itself. In particular, the wide rider bands are required to keep within allowable limit the contact pressure between rider bands and liner, to reach the desired component life (especially in dry service).

However, this wide arrangement has several drawbacks, such as overheat, alignment issues, and overloads due to the weight of the long pistons.

In fact, special precautions are required for horizontally arranging the pistons, to avoid any undesired stresses while operating. Furthermore, as it can be understood, the greater the length of the pistons, the greater the weight, thus increasing the alignment problems.

Therefore, in order to reduce piston overall length or to keep it within a reasonable value, sometimes shorter rider bands with increased specific pressure are installed, which is sometimes detrimental the component life.

This problem prevents or limits the application of horizontally balanced compressors in dry services in favor of compressors with vertical cylinder arrangement which, on the other hand, may have unbalancing issues when the size of the piston-cylinder assembly increases.

Accordingly, an improved bearing for supporting a piston in a reciprocating compressor would be welcomed in the technology to solve the above-mentioned problems.

### SUMMARY

A new magnetic bearing for supporting the movement of a piston has been discovered and is disclosed herein. The new magnetic bearing can for instance be used in compressors and similar reciprocating machines, especially used in gas pipelines, natural gas plants, and the like.

In one aspect, the subject matter disclosed herein is directed to a magnetic bearing for supporting a piston sliding into a cylinder of a compressor, specifically a reciprocating compressor. The piston is comprised of a first rod, connecting a cross-head of the compressor, and an extension rod. The magnetic bearing comprises a first group of magnets arranged on a first side of the extension rod of the piston, and a second group of magnets arranged on a second side of the extension rod. The magnetic forces exerted by the first group of magnets and the second group of magnets allow the piston to be supported during its movement.

In another aspect, the subject matter disclosed herein concerns that the first group of magnets has two permanent magnets facing with opposite polarity, while the second group of magnets comprises two permanent magnets facing with the same polarity. In another aspect, disclosed herein is that the first group of magnets comprises two permanent magnets facing with the same polarity, thus generating a repulsive force, and the second group of magnets comprises two permanent magnets facing with the same polarity, thus generating a repulsive force between them. The first group of magnets may comprise a plurality of electromagnets, and the second group of magnets may comprise two permanent magnets facing with the same polarity. Alternatively, the first group of magnets may comprise a plurality of electromagnets.

In another aspect, the magnetic bearing is a passive magnetic bearing surrounding the extension rod of the piston. The cylinder comprises a stator, while the passive magnetic bearing comprises two-cylinder magnets facing with the same polarity. The first cylinder magnet is arranged on the stator of the cylinder and the second magnet is arranged on the extension rod of the piston.

In another aspect of the invention, the subject matter disclosed herein is directed to a magnetic bearing comprising a plurality of permanent magnets installed on a second side of the extension rod and arranged in a Halbach array configuration. In this way, the magnetic force increases on one side of the magnets and cancel the magnetic force on the other side of the magnets. The magnetic bearing also comprises a plurality of closed coils facing the magnets, such that, when the position of the magnets due to the axial piston movement changes, parasite currents flowing on the coils are created which tend to oppose the movement of the magnets uplift the piston.

### BRIEF DESCRIPTION OF THE DRAWINGS

A more complete appreciation of the disclosed embodiments of the invention and many of the attendant advantages thereof will be readily obtained as the same becomes better understood by reference to the following detailed description when considered in connection with the accompanying drawings, wherein:

FIG. 1 illustrates a perspective view of a reciprocating compressor, according to the prior art;

FIG. 2 illustrates a lateral view of a horizontal cylinder of the reciprocating compressor equipped with a magnetic bearing, according to the present invention;

FIG. 3 illustrates a lateral and detailed view of the horizontal cylinder of FIG. 2 equipped with a couple of permanent magnets facing with opposite polarity on a first side of the piston rod and a further couple of permanent magnets facing with the same polarity on a second side of the piston rod, according to a first embodiment;

FIG. 4 illustrates a lateral and detailed view of the horizontal cylinder of FIG. 2 equipped with a couple of permanent magnets facing with the same polarity on the first side of the piston rod and another couple of permanent magnets facing with the same polarity on the second side of the piston rod, according to a second embodiment;

FIG. 5 illustrates a lateral and detailed view of the horizontal cylinder of FIG. 2 equipped with active magnets on the first side of the piston rod and a couple of permanent magnets facing with the same polarity on the second side of the piston rod, according to a third embodiment;

FIG. 6 illustrates a lateral and detailed view of the horizontal cylinder of FIG. 2 equipped with the active magnets on the first side of the piston rod, according to a fourth embodiment;

FIG. 7 illustrates a perspective view of a portion of the horizontal cylinder of FIG. 2 equipped with permanent magnets with radial polarization around the piston rod, according to a fifth embodiment;

FIG. 8 illustrates a cross sectional view of the horizontal cylinder of FIG. 2 equipped with active magnets arranged on a U-shaped piston rod, according to a sixth embodiment;

FIG. 9 illustrates a perspective view of a permanent magnet, according to another embodiment;

FIG. 10 illustrates the magnetic flux of magnetic blocks and their arrangement polarity the permanent magnet of FIG. 9; and

FIG. 11 illustrates a flowchart of a method of assembling a magnetic bearing configured to support the movement of a piston.

### DETAILED DESCRIPTION OF EMBODIMENTS

Reciprocating compressors are machines designed to deliver gases at high pressure. The reciprocating compressors comprise pistons for compressing the gas. However, such compressors typically have balancing and alignment problems due to their weight and length. According to one aspect of the invention, the pistons of reciprocating compressors are equipped with magnets that support and align the pistons during their movement to reduce wear and friction and to improve the operating efficiency of the reciprocating compressor.

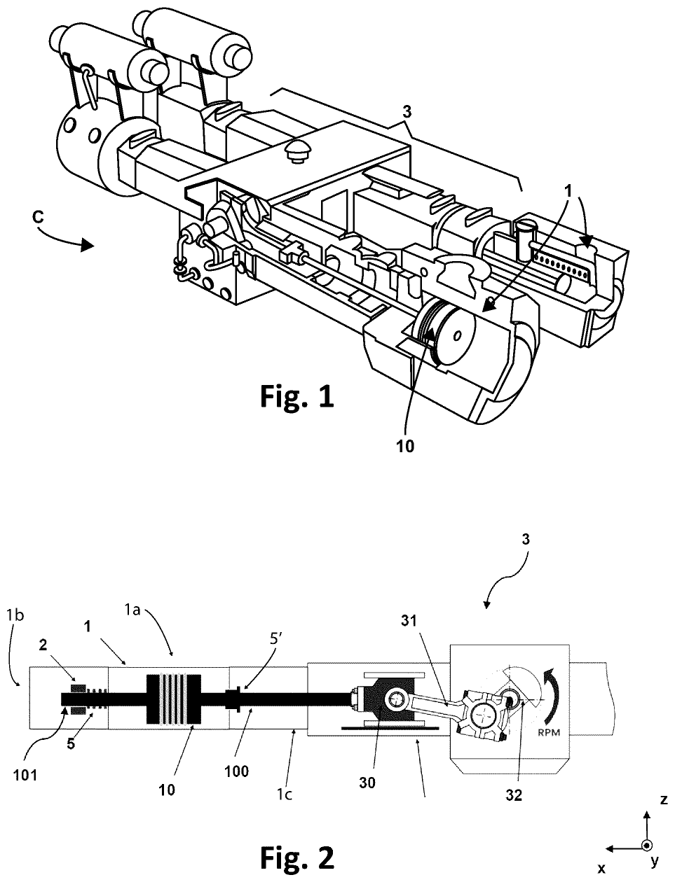

Referring now to the drawings, FIG. 1 shows a partial section of a perspective view of a reciprocating compressor, indicated with the reference letter C, comprising two horizontal cylinders 1, each of which is independently connected to a crankcase assembly 3. The cylinders 1 are arranged parallel to each other and each one has a piston 10.

Specifically, FIG. 2 show in detail a connection between one of the horizontal cylinders 1, equipped with a new magnetic bearing 2 as better explained below, and the crankcase assembly 3. The cylinder 1 is aligned to the X-axis of the Cartesian frame of reference of FIG. 2. Hereafter, for ease of reference only, the horizontal cylinder 1 may also be referred to as cylinder 1.

The horizontal cylinder 1 comprises a first portion or cylinder body 1a, a second portion or cylinder head 1b, which is connected to the first portion 1a, and a third portion, or distance piece 1c, which is also connected to the first portion 1a.

Typically, the compression cycle occurs in the first portion 1a, double-acting as shown in FIG. 2 with two gas chambers on the two sides of the pistons, making the same compression stage. However, in other embodiments, other cylinder designs could be implemented, e.g., two gas chambers, in which one chamber is at a constant pressure, or tandem cylinder.

The second portion 1b encloses the horizontal cylinder 1. It allows the passage and motion of a tail rod of the piston 10 and houses tail rod packing. Typically, it operates at a pressure close to atmospheric pressure.

The third portion 1c can be a single compartment or a double compartment. In case of the third portion 1c is a double compartment, there are two chambers between the first portion 1a and the crankcase assembly 3, and an additional packing (called intermediate packing) is included in the third portion 1c. The horizontal cylinder 1 comprises a piston 10, which can slide into the horizontal cylinder 1. In particular, referring to the embodiment at issue, the piston 10 performs lateral movements along a direction parallel or substantially parallel to an axis X of a Cartesian reference system XYZ (shown in FIG. 2).

According to the present disclosure, also, the piston 10 comprises a first rod 100, which connects the piston 10 to the crankcase assembly 3. In particular, the piston 10 is connected, through the first rod 100, to a cross-head 30, which is then connected, in its turn, to a crankshaft 32 through a connecting rod 31, and a second rod or extension rod 101, which is connected to the first rod 100.

Moreover, the horizontal cylinder 1 comprises a first packing or tail rod packing or head end packing 5, which is arranged on the extension rod 101, and a second packing or crank end packing 5′, which is arranged on the first rod 100.

The first packing 5 avoids leakages of gas from the first portion 1a to the second portion 1b. Instead, the second packing 5′ avoids leakages of gas from the first portion 1a to the third portion 1c.

The magnetic bearing 2 illustrated in FIG. 2, is arranged on the second rod 101 of the piston 10, so as to support the piston 10 during its axial movement. In particular, as will be explained in more detail below, the magnetic bearing 2 comprises magnets 200, 201, 210, 211, which can be permanent magnets, active or mixed permanent and active magnets, having both attractive and repulsive magnetic forces between each other, depending on their reciprocal arrangement.

Furthermore, such magnets 200, 201, 210, 211 may have different geometries. Specifically, the magnets 200, 201, 210, 211 may have the shape of cubes, blocks or tailored shapes depending on the location of the installation. Moreover, the magnets 200, 201, 210, 211 may be based on different grades of neodymium (NdFeB), row or nickel-plated, Samarium-cobalt magnets (SmCo) or Aluminum-nickel-cobalt magnets (AlNiCo).

In some embodiments, the magnets 200, 201, 210, 211 may be accommodated on dedicated cavities (not shown in the figures) created on the rod 101 of the piston 10 or on the piston 10. In other embodiments, the magnets 200, 201, 210, 211 may also be installed on an additional dedicated component clamped to piston rod 101 or piston 10.

In some other embodiments, the number, the position and the type of the magnetic bearing 2 may be different. In particular, in some embodiments, the magnetic bearing 2 is arranged on the first rod 100. In such embodiment, the piston 10 does not comprise any second rod 101. In a further embodiment, the magnetic bearing 2 is arranged on the external surface of the piston 10. Also in this embodiment, the piston 10 does not comprise any second rod 101.

Furthermore, according to the present disclosure, the magnetic bearing 2 replaces all the rider bands (which are not shown in the figures) of the cylinder 1. However, in some other embodiments, the magnetic bearing 2 can be installed in parallel to the rider bands to reduce their axial width on the reciprocating compressor.

As explained below, the magnets 200, 201, 210, 211 are oriented such that to exert attractive or repulsive force to the shaft depending on the configuration or how they are arranged. Typically, the force vector is perpendicular to the rod 100,101 or piston 10 axis, i.e., to the X-axis of the Cartesian reference frame XYZ.

In other embodiments, the magnets 200, 201, 210, 211 may be fixed to the rod 100, 101 of the pistons 10 with epoxy resin, screws or simply attractive forces to a dedicated support made of magnetic material. The gap between the magnets 200, 201, 210, 211 and the piston 10 is varying depending on the size of the unit, the weight of the piston 10 and the location of the magnets 200, 201, 210, 211. In particular, a typical gap ranges from 0.1 to 50 mm (different value can be required depending on the specific solution arrangement). Typically, the larger is the gap, the stronger the magnetic force to sustain the piston 10 should be. In fact, the magnets 200, 201, 210, 211 allow supporting the piston 10 and its weight during its axial movement.

Thanks to the operation of the magnetic bearings the overheat is prevented since less mechanical parts interact each other. Also, by the solution disclosed the alignment of the horizontal piston is improved since a possible adjustment of the position of the piston 10 an be done without necessarily dismount mechanical parts.

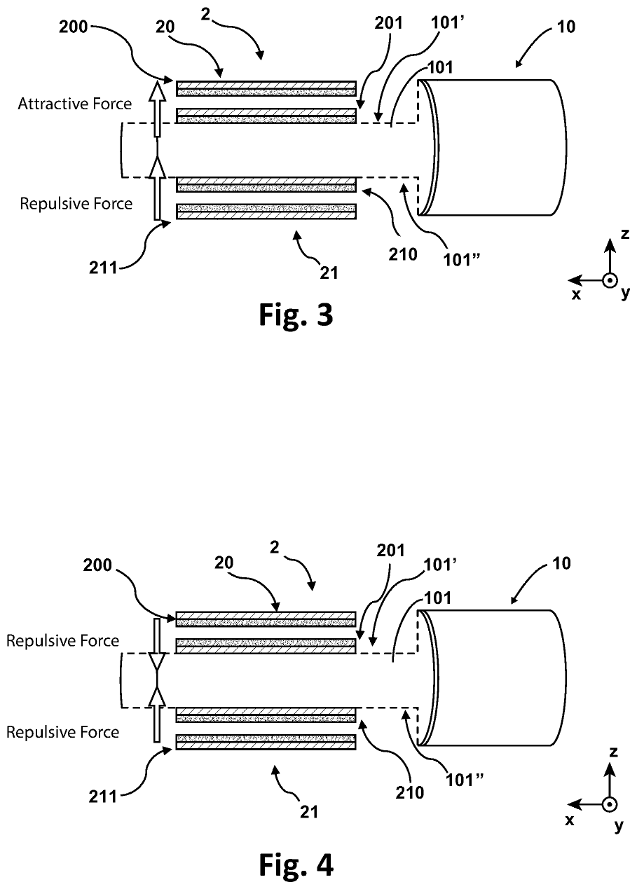

Referring now to FIG. 3 a first embodiment of the magnetic bearing 2, installed on the piston 10, is illustrated, wherein a first group of permanent magnets 20 is arranged on a first side 101′ of the second rod 101 of the piston 10, while a second group of permanent magnets 21 is arranged on a second side 101″ of the second rod 101 the piston 10.

In particular, the first group of permanent magnets 20 comprises two permanent magnets 200, 201 facing with opposite polarity, while the second group of permanent magnets 21 comprises two permanent magnets 210, 211 facing with the same polarity.

Therefore, the magnets 200, 201, facing each other with the opposite magnetic polarity, attract each other, i.e., there is an attractive force between the two magnets 200, 201. On the other hand, the magnets 210, 211, facing each other with the same magnetic polarity, repel each other, i.e., there is a repulsive force between the two magnets 210, 211.

Specifically, according to the present disclosure, the force exerted by the magnets 200, 201 on the first side 101′ of the second rod 101 of the piston 10 is less than the force exerted by the other magnets 210, 211 on the second side 101″ of the second rod 101 of the piston 10. Therefore, this magnetic arrangement allows reducing the load on the other components of the cylinder 1 in contact with the piston 10.

As shown in FIG. 4, according to a second embodiment, the first group of magnets 20, which is arranged on the first side 101′ of the second rod 101 of the piston 10, comprises two magnets 200, 201 facing with same polarity, so as to repel each other. The second group of permanent magnets 21, which is arranged on the second side 101″ of the second rod 101 the piston 10, comprises in its turn two magnets 210, 211 facing with the same polarity.

Therefore, the magnetic arrangement of FIG. 4 allows the piston 10 to be supported during its movement since no magnetic interferences due to undesired magnetic fields or fluxes are created around the magnets 200, 201, 210, 211.

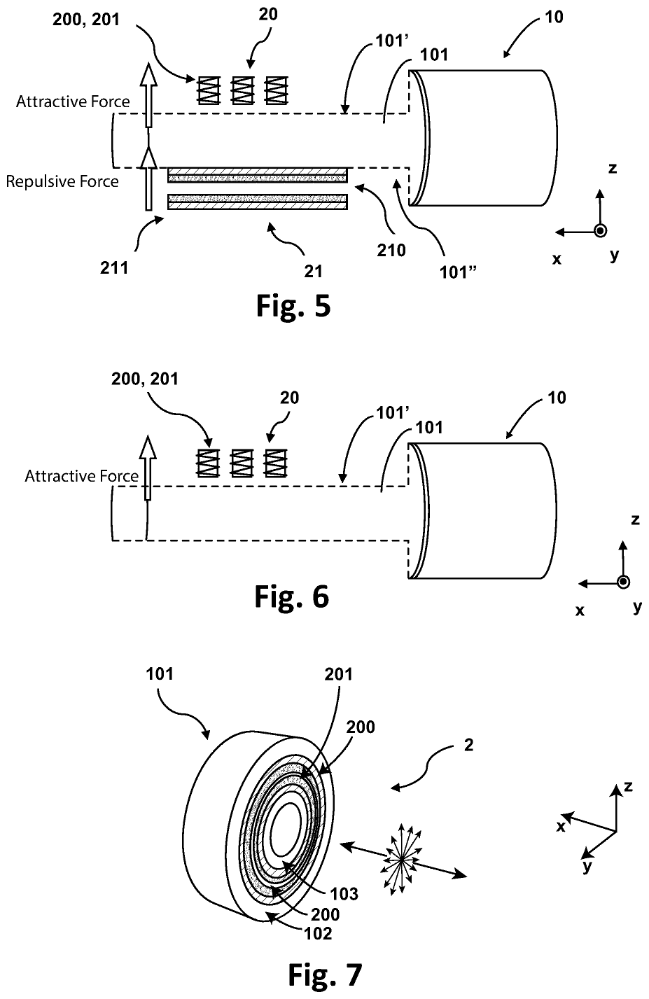

Referring now to FIG. 5, a third embodiment of the magnetic bearings is illustrated, where the first group of magnets 20 comprises a plurality of electromagnets 200, 201 arranged on the first side 101′ of the second rod 101 of the piston 10, wherein the magnetic field is generated by an electric current flowing through them. Each electromagnet 200, 201 comprises a core of ferromagnetic material onto which a solenoid is wound, i.e., a coil made of several loops of electric wire. However, in some other embodiments, the type and position of the electromagnets 200, 201 may be different.

Furthermore, the second group of magnets 21 comprises two permanent magnets 210, 211. The two permanent magnets 210, 211 face each other so as to oppose the same polarity. Then the second group of magnets 21 is arranged on the second side 101″ of the second rod 101 the piston 10.

Therefore, with such active magnetic bearings 2 it is possible to modulate and adjust the intensity of the magnetic field generated by means of a variation of the electric current. On the other hand, the magnets 210, 211 face with the same magnetic polarity, to repel each other, i.e., there is a repulsive force between the two magnets 210, 211.

A fourth embodiment is shown in FIG. 6, where the electromagnets 200, 201 are arranged on the first side 101′ of the second rod 101 of the piston 10, while the second side 101″ of the second rod 101 of the piston 10 is free of magnets. In particular, the electromagnets 200, 201 actively control the position of the piston 10 and they are operating on the flat surface of the piston 10.

As shown in FIG. 7, according to a fifth embodiment, the magnetic bearing 2 is a passive magnetic bearing 2 surrounding the second rod 101 of the piston 10 so as to ensure radial stability. In particular, the passive magnetic bearing 2 comprises a couple of cylinder magnets 200, 201 facing with the same polarity. The first magnet 200 is arranged on the stator 102 of the cylinder 1, while the second magnet 201 is mounted or installed on the second rod 101 of the piston 10. In some embodiments, the magnet 200 installed on stator parts may also be installed on cavities created on cylinder liner (not shown in the figures) or in external magnet carrier. In these cases, dedicated seats or shaped geometry have to be created on cylinder to avoid interference during the piston movements. Stator magnet 200 may also be installed embedded on static components below cylinder internal surfaces.

The repulsive force between the two magnets 200, 201 is homogeneous, thus allowing the radial alignment, while ensuring the movement of the piston 10 along the X-axis.

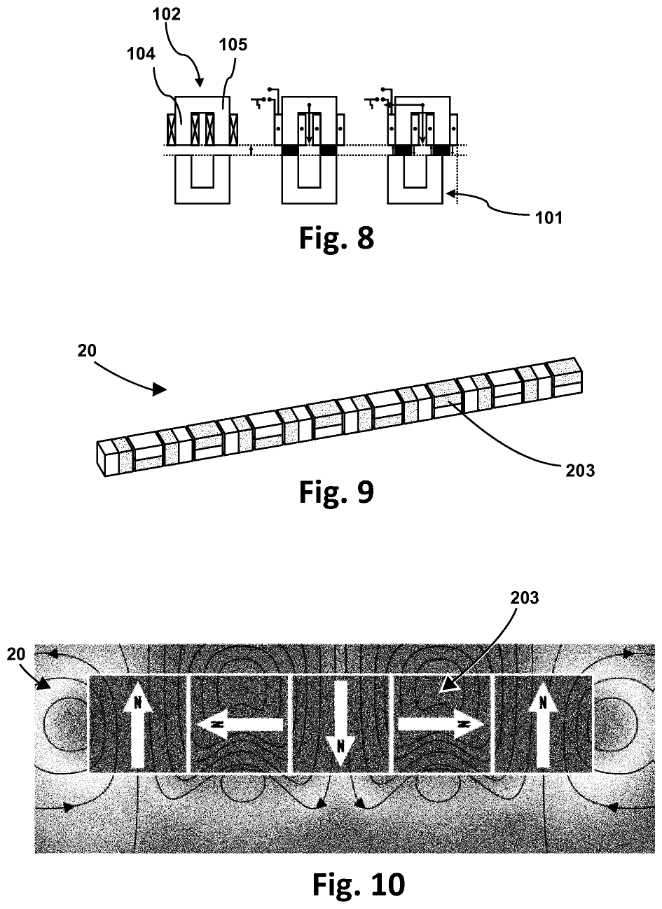

As shown in FIG. 8, according to a sixth embodiment of magnetic bearings 2, the second rod 101 is substantially U-shaped. However, in other embodiments, the shape of the piston 10 may be different. The first group of active magnets 20 is arranged on a first side portion 104 of the top of the piston stator 102, while a second group of active magnets 21 is arranged on a second side portion 105 of the top of the piston stator 102. In particular, the electromagnets 20, 21 actively control the position of the second rod 101 during the axial movement, while the U-shape of the second rod 101 is granting the lateral guidance.

As shown in FIG. 9, according to another embodiment, a plurality of permanent magnets 210, 211 is arranged in a Halbach array configuration, which is an arrangement of permanent magnets that makes the magnetic field on one side of the array stronger, while canceling the field to near zero on the other side.

Therefore, permanent magnets 210, 211 are arranged such as to form a spatially rotating magnetic field vector, which has the effect of focusing and augmenting the magnetic field on one side, while canceling it out on the other side. In particular, the orientation of the magnetic field of the single magnets 210, 211 are alternated in such a way to double the magnetic force on the wanted side nulling the force on the opposite side. Moreover, permanent magnets 210, 211 are positioned at the bottom and they have the purpose of supporting the piston rod during the axial movement. Furthermore, the Halbach array is installed on the second side 101″ of the second rod 101 of the piston 10.

Therefore, this arrangement makes it possible to increase the magnetic force on one side of the magnets 210, 211 and cancel it on the other side. In particular, there are a plurality of closed coils 4 installed on the bottom of the piston stator 102. The coils 4 face the Halbach array mounted on the bottom of the second side 101″ of the second rod 101 of the piston 10, such that, when the position of the permanent magnets 210, 211 changes, parasite currents flowing on these coils 4 are created which tend to oppose the movement of the series of magnets 210, 211 and the effect is one of uplifting/the piston rod 10.

In particular, referring to FIG. 9, a permanent magnet 20 (or 21) embodiment for passive magnetic bearing based on a Halbach array is illustrated. The permanent magnet 20 has the form of a bar made of an array of magnetic blocks 203, arranged in a special pattern as shown in the figure. Each magnetic block 203 is at right angle to the orientations of the adjacent magnetic block 203. When the magnetic blocks 203 are placed in this configuration, the magnetic field lines combine to produce a very strong field below the array. Above the array, the field lines cancel one another out, as can be seen in FIG. 10, where the magnetic flux of the different magnetic blocks 203 and their arrangement polarity is illustrated. This embodiment of magnetic blocks 203 turn out to be more powerful than the common permanent magnets, with a more confined magnetic flux.

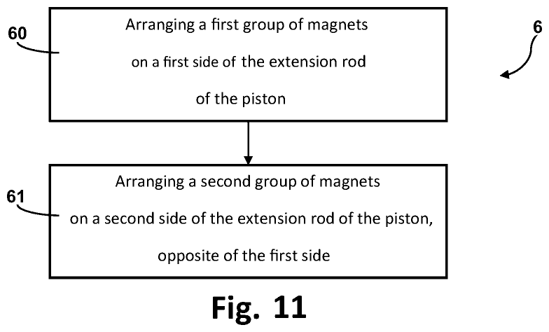

Referring now to FIG. 11, the steps of a method 6 of assembling the magnetic bearing 2 on the piston 10, according to a first embodiment, are shown.

In the assembling method 6, a first step of arranging 60 a first group of magnets 20 on a first side 101′ of the extension rod 101 of the piston 10 is carried out. Then, a step of arranging 61 a second group of magnets 21 on a second side 101″ of the extension rod 101 of the piston 10, opposite of the first side 101′, is carried out.

In particular, the magnets 200, 201, 210, 211, which are comprised in the first and second groups of magnets, are oriented such that to exert attractive or repulsive force to the shaft depending on the configuration or how they are arranged. In some embodiments, the magnets 200, 201, 210, 211 may be accommodated on dedicated cavities (not shown in the figures) created on the rod 101 of the piston 10 or on the piston 10.

Moreover, the assembling method 6 allows supporting the movement of the piston 10 by means of the magnetic forces exerted by the first group of magnets 20 and the second group of magnets 21 respectively.

An advantage of the present disclosure is the reduction of the wear of the components, such as the reduction or removal of the wear of the rider bands introducing a frictionless device.

Another advantage of the present disclosure is the reduction of the component's maintenance and an increase of machine availability.

It is also an advantage of the present disclosure the reduction of operating expense.

A further advantage of the present disclosure is to extend applicability of horizontally balanced compressors in dry applications.

Another advantage of the present disclosure is the possibility to increase the number of piston rings for high pressure and dry services.

It is an advantage of the present disclosure the reduction and the better control of the piston vibrations during its axial movement which may help to reduce the clearances between the cylinder bore and piston, enabling installation of other types of piston sealing requiring such reduced clearance.

While aspects of the invention have been described in terms of various specific embodiments, it will be apparent to those of ordinary skill in the art that many modifications, changes, and omissions are possible without departing and scope of the claims. In addition, unless specified otherwise herein, the order or sequence of any process or method steps may be varied or re-sequenced according to alternative embodiments.

Reference has been made in detail to embodiments of the disclosure, one or more examples of which are illustrated in the drawings. Each example is provided by way of explanation of the disclosure, not limitation of the disclosure. In fact, it will be apparent to those skilled in the art that various modifications and variations can be made in the present disclosure without departing from the scope or spirit of the disclosure. Reference throughout the specification to “one embodiment” or “an embodiment” or “some embodiments” means that the particular feature, structure or characteristic described in connection with an embodiment is included in at least one embodiment of the subject matter disclosed. Thus, the appearance of the phrase “in one embodiment” or “in an embodiment” or “in some embodiments” in various places throughout the specification is not necessarily referring to the same embodiment(s). Further, the particular features, structures or characteristics may be combined in any suitable manner in one or more embodiments.

When elements of various embodiments are introduced, the articles “a”, “an”, “the”, and “said” are intended to mean that there are one or more of the elements. The terms “comprising”, “including”, and “having” are intended to be inclusive and mean that there may be additional elements other than the listed elements.

1. A compressor with a magnetic bearing, the compressor comprising a piston, a crankcase assembly and a cylinder; the magnetic bearing being configured to support the movement of the piston sliding into the cylinder comprised in the compressor, wherein the piston comprises a first rod which connects the piston to a crankcase assembly of the compressor and an extension rod, which is connected to the first rod, wherein the magnetic bearing comprises:
a first group of magnets arranged on a first side of the extension rod of the piston; and
a second group of magnets arranged on a second side of the extension rod of the piston, wherein the first side and the second side are opposing sides in a radial extension of the extension rod,
wherein the magnetic forces exerted by the first group of magnets and the second group of magnets respectively allow the piston to be supported during its movement.

2. The magnetic bearing according to claim 1,
wherein the first group of magnets comprises two permanent magnets facing each other with opposite polarity, so as to generate an attractive force between the two magnets, and
wherein the second group of magnets comprises two permanent magnets facing each other with the same polarity, so as to generate a repulsive force between the two magnets.

3. The magnetic bearing according to claim 1,
wherein the first group of magnets comprises two permanent magnets facing with the same polarity, so as to generate a repulsive force between the two magnets, and
wherein the second group of magnets comprises two permanent magnets facing with the same polarity, so as to generate a repulsive force between the two magnets.

4. The magnetic bearing according to claim 1,
wherein the first group of magnets comprises a plurality of electromagnets and
wherein the second group of magnets comprises two permanent magnets facing with the same polarity, so as to generate a repulsive force between the two magnets.

5. The magnetic bearing according to claim 1, wherein the first group of magnets comprises a plurality of electromagnets.

6. The magnetic bearing according to claim 1,
wherein the magnetic bearing is a passive magnetic bearing surrounding the extension rod of the piston, wherein the cylinder comprises a stator, and
wherein the passive magnetic bearing comprises two cylinder magnets facing with the same polarity, the first cylinder magnet being arranged on the stator of the cylinder and the second magnet being arranged on the extension rod of the piston.

7. The magnetic bearing according to claim 1,
wherein the extension rod is substantially U-shaped, and
wherein the first group of magnets is radially arranged on a first side portion of a U-shape bearing stator and the second group of magnets is radially arranged on a second side portion of the U-shape bearing stator, wherein the first side portion and the second side portion are straight and opposite sections of the U-shape bearing stator.

8. The magnetic bearing according to claim 1, comprising:
a plurality of permanent magnets installed on a second side of the extension rod of the piston and arranged in a Halbach array configuration so as to increase the magnetic force on one side of the magnets and cancel the magnetic force on the other side of the magnets; and
a plurality of closed coils facing the magnets, such that, when the position of the magnets due to the axial piston movement changes, parasite currents flowing on the coils are created which tend to oppose the movement of the magnets uplift the piston.

9. The magnetic bearing according to claim 1, wherein the cylinder is a horizontal cylinder and the compressor is a reciprocating compressor.

10. The magnetic bearing according to claim 1, wherein the first group of magnets and/or the second group of magnets are made of array of magnetic blocks arranged according to the Halbach pattern.

11. A method of assembling a magnetic bearing configured to support the movement of a piston sliding into a cylinder comprised in a compressor, wherein the piston comprises a first rod, which connects the piston to a crankcase assembly of the compressor and an extension rod, which is connected to the first rod, comprising the steps of:
arranging a first group of magnets on a first side of the extension rod of the piston; and
arranging a second group of magnets on a second side of the extension rod of the piston, opposite of the first side;
wherein the movement of the piston is supported by means of the magnetic forces exerted by the first group of magnets and the second group of magnets respectively.
